(19) United States
(12) Patent Application Publication
(10) Pub. No.: US 2022/0363207 A1
(43) Pub. Date: Nov. 17, 2022

(54) TRAILER BRAKE LIGHT ADAPTER

(71) Applicant: SecurPlus Solutions Inc., Montreal (CA)

(72) Inventors: Vincent Gallo, Montreal (CA); Daniel Roux, Saint-Joseph-du-Lac (CA); Andy Verbeek, Winnipeg (CA); Trevor Williams, Brossard (CA)

(21) Appl. No.: 17/663,782

(22) Filed: May 17, 2022

Related U.S. Application Data
(60) Provisional application No. 63/189,447, filed on May 17, 2021.

(51) Int. Cl. B60R 16/023; B60D 1/64; H01R 31/06

(52) U.S. Cl. CPC B60R 16/023; B60D 1/64; H01R 31/065; H01R 2201/26

(57) ABSTRACT

A trailer adapter for connecting a trailer's electrical wiring for brake lights, turn signals, etc. includes circuitry for pulsing brake lights when the brakes are first applied.

### CROSS-REFERENCE TO RELATED APPLICATIONS

This application claims the benefit of U.S. Provisional Application No. 63/189,447, filed May 17, 2021, the contents of which are expressly incorporated herein by reference.

### STATEMENT RE: FEDERALLY SPONSORED RESEARCH/DEVELOPMENT

Not Applicable

### BACKGROUND

### Technical Field

The current disclosure relates to an adapter for electrical connections between a vehicle and a trailer.

### Background

Brake lights on a vehicle may be pulsed briefly when applying the brakes in order to increase visibility or attention to the brake lights of following drivers. Brake lights on existing vehicles may be modified in order to provide flashing functionality in order to increase the safety of the vehicle. Such flashing functionality is typically provided by modifying the existing brake light wiring, or brake light itself, in order to install the flashing circuitry. Similar flashing circuitry can be installed into the brake lights of trailers that can be towed by a vehicle.

While the brake light flashing circuitry may provide safety benefits, the installation requires familiarity with the electrical wiring of the vehicle and/or trailer. Additionally, the installation may require skills and/or tools beyond those of average drivers.

An additional, alternative and/or improved apparatus for use in flashing brake lights is desirable.

### BRIEF SUMMARY

In accordance with the present disclosure there is provided an adapter for a trailer's brake/signal lights comprising: brake light flashing circuitry comprising a brake signal input and a brake signal output that is pulsed when a brake signal is applied at the brake signal input; a first half of a vehicle-trailer connector comprising a plurality of physical electrical connections for removably connecting to a vehicle connection or a trailer connection, at least one of the electrical connections of the first half of the vehicle-trailer connector electrically connected to the brake signal input or the brake signal output of the bra9ke light flashing circuitry; and a body at least partially enclosing the brake light flashing circuitry and the first half of the vehicle-trailer connector.

In a further embodiment of the adapter, the first half of the vehicle-trailer connector comprises a vehicle side connector and is electrically connected to the brake signal output of the brake light flashing circuitry.

In a further embodiment of the adapter, the first half of the vehicle-trailer connector comprises a trailer side connector and is electrically connected to the brake signal input of the brake light flashing circuitry.

In a further embodiment of the adapter, the first half of the vehicle-trailer connector comprises a first half of one of: a 7-pin round connector; a 7-pin flat connector; a 6-pin round connector; a 5-pin flat connector; and a 4-pin flat connector.

### BRIEF DESCRIPTION OF THE DRAWINGS

Further features and advantages of the present disclosure will become apparent from the following detailed description, taken in combination with the appended drawings, in which:

FIG. 1 depicts a truck and trailer incorporating a brake light adapter according to the current disclosure;

FIG. 2 depicts a further brake light adapter;

FIG. 3 depicts a further brake light adapter; and

FIG. 4 depicts an illustrative schematic of light flashing circuitry.

### DETAILED DESCRIPTION

An adapter for connecting a trailer's electrical wiring to the tow vehicle's electrical wiring is described that incorporates light flashing circuitry that flashes or pulses brake lights before steadily applying the brake lights when the brake is applied. Incorporating the flashing circuitry into the body of the adapter greatly simplifies the installation of the brake flashing circuitry. The adapter with the flashing circuitry can be plugged into existing connectors for the vehicle-to-trailer electrical connections, allowing the flashing circuitry to be easily incorporated into the vehicle/trailer.

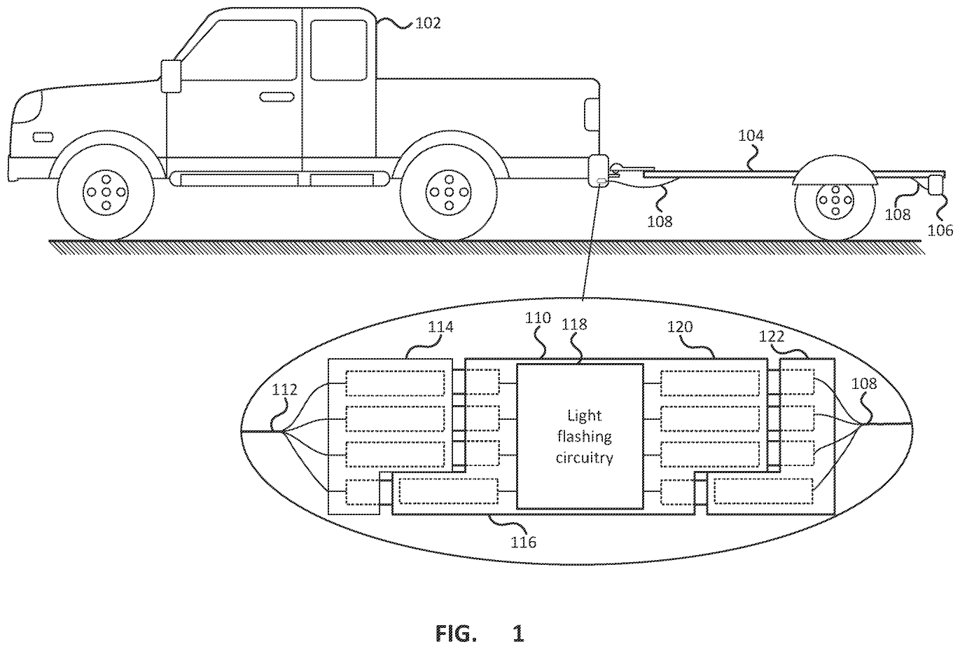

FIG. 1 depicts a truck and trailer incorporating a brake light adapter according to the current disclosure. An automobile 102, such as a truck, may include equipment for towing a trailer 104. The trailer includes brake lights, turn signals etc. 106 that are electrically connected to the tow vehicle 102 by respective electrical wiring connected through a vehicle-trailer adapter 110. The vehicle-trailer adapter 110 provides a physical electrical connection from the vehicle's electrical wiring 112 and the trailer's electrical wiring 108 allowing the vehicle 102 to control the trailer lights. The vehicle's wiring is terminated by a vehicle side connector 114 that provides half of a physical connection. The vehicle side connector 114 has a physical shape for connecting to a corresponding connector 116 on the adapter 110. The vehicle side connector 114 and the adapter connector 116 have corresponding physical features to ensure that the two connectors can only be connected together in one orientation to ensure that the correct wire connections are established. The connectors 114 and 116 are depicted as a 4-pin trailer connector.

The adapter 110 includes light flashing circuitry 118 that uses the electrical connections to the vehicle wires as input and provides corresponding output signals that cause brake lights to flash or pulse before being applied steadily when the tow vehicle's brakes are applied. The light flashing circuitry may be provided in various ways. While it is possible to provide the functionality using, for example, a microcontroller, doing so would require the microcontroller to be powered. Depending upon the vehicle connector, power may only be provided to the adapter when the brakes are applied. Accordingly, the light flashing circuitry may be provided using simpler components, such as timer circuits such as a 7555 timer integrated circuits, counting circuits, such as 4024 integrated circuits, and other electronic components such as resistors, capacitors, transistors, etc. Regardless of how the electrical circuit is implemented, it flashes brake lights of the trailer, and then holds them steady, when the brakes are applied, or more particularly, when there is a brake light signal applied at the vehicle connector 114.

As depicted, in addition to the adapter's connector 116 that connects to the vehicle connector 114, the adapter 110 further includes a connector 120 for connecting to a corresponding trailer connector 122. The connectors 120 and 122 connector have corresponding physical features to ensure that the two connectors can only be connected together in one orientation to ensure that the correct wire connections are established. The connectors 120 and 122 are depicted as a 4-pin trailer connector, which is the same as connectors 114 and 116. Although both connectors of the adaptor are depicted as being a respective portions of 4-pin train connectors, it will be appreciated that each connector 116, 120 of the adapter 110 may be different from the other as long as it matches the respective mating end of the vehicle or trailer.

Without the adapter 110, the trailer's wiring connector 122 may be connected directly to the vehicle's connector 114 such that when the brakes are applied, the trailer's brake lights will light up without pulsing or flashing. The adapter 110 may be inserted into the connection between the trailer and vehicle by connecting the adapter to the vehicle connector 114 and the trailer connector 122. With the adapter 110 connected, the trailer's brake lights flash/pulse when the vehicle's brakes are first applied before being held on while the brakes remain applied.

The adapter described above is provided as a single unitary body that encloses the light flashing circuitry as well as the physical connectors for connecting the adapter 110 to the vehicle, and the trailer to the adapter. Although depicted as a single adapter with respective portions of a 4-pin trailer adapter, various different implementations of an adapter are possible that allow light flashing circuitry to be plugged into a connector of the vehicle-trailer electrical connection.

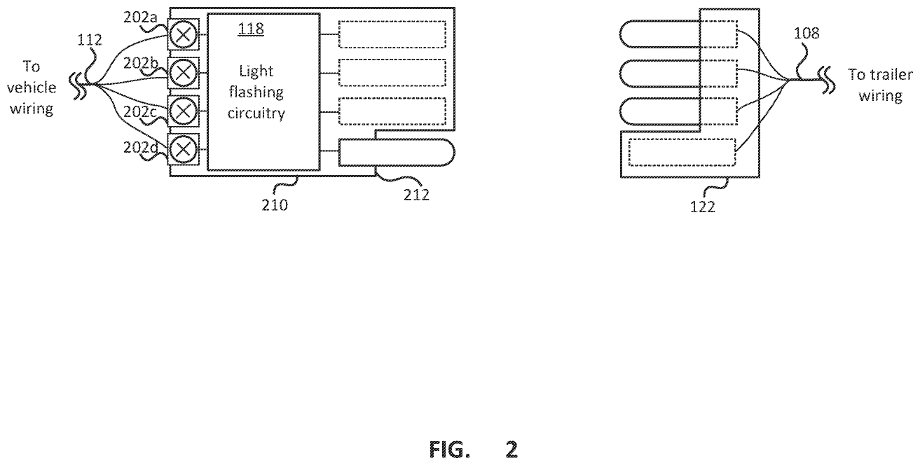

FIG. 2 depicts a further brake light adapter. The adapter 210 provides similar functionality as the adapter 110 described above. In contrast to the adapter 110 which included two separate physical connectors for connecting respectively to the vehicle's electrical connector and the trailer's electrical connector, the adapter 210 comprises a single physical connector 212 for connecting to the trailer's connector 122. The adapter 210 comprises light flashing circuitry 118 electrically connected to the electrical connections of the physical connector 122. The physical connector 122 comprises corresponding features with the connector on the trailer that ensures that the connectors can only connected together in a single orientation. As depicted, instead of a second physical connector for connecting the adapter to a corresponding connector of the vehicle, the adapter 122 includes a number of individual connectors 202a, 202b, 202c, 202d (referred to collectively as individual connectors 202) for directly securing the electrical wires 112 of the vehicle to the adapter. The individual connectors 202 are depicted as terminal blocks that allow individual wires to be secured to the blocks. The individual connectors 202 may be provided in other ways including, for example push connectors, solder pads, wires, etc. With the adapter 210 secured to the vehicle's electrical wires 112 the trailer connector 122 may be plugged in to the physical connector 212 of the adapter in order to connect the electrical wiring of the trailer to the vehicle's wiring system. The adapter 210 provides light flashing functionality to the brake lights of the trailer simply by plugging the trailer connector into the adapter.

The above has described an adapter that allows any trailer that is plugged into the vehicle with the adapter to benefit from the brake light flashing functionality. It is possible to provide the brake light flashing functionality to the trailer connection.

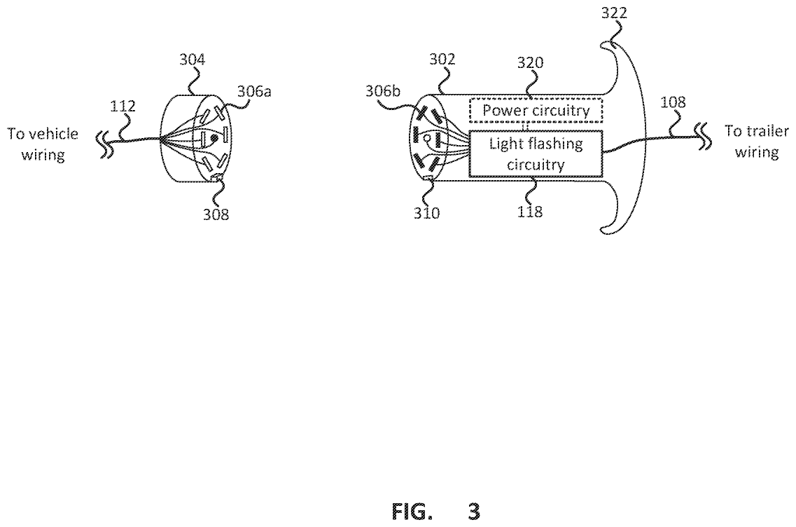

FIG. 3 depicts a further brake light adapter. The adapter 302 is depicted as being a 7-pin round trailer connector, although other connector types and pin numbers may be used. The round adapter 302 can be plugged into a corresponding physical connector 304 on the vehicle. The connector 304 provides electrical connections 306a for the vehicle's electrical wires. When the adapter is plugged into the connector, corresponding electrical connectors 306b make electrical contact with the electrical connections 306a, and so the vehicle's wiring 112. Each half of the vehicle-trailer connection, namely the connector 304 and the adapter 302, may comprise some corresponding features 308, 310 that interact with each other to ensure that the connection can only be made in one orientation.

The adapter 302 comprises a body that encloses the electrical connections 306b as well as the light flashing circuitry 118. The adapter 302 may include additional circuitry including power circuitry 320 that may provide power to additional components from the electrical connection to the vehicle. Depending upon the type of connections, one or more of the electrical wires may provide a power signal. For example, the adapter may include additional electronics for providing various features such as cameras, location functionality for determining a position of the trailer, communication functionality, etc. Regardless of any additional functionality provided by the adapter, the light flashing functionality is electrically connected between the electrical connections 306b to the vehicle and the trailer's wiring 108. The adapter may include a housing for enclosing the electrical connections and the light flashing circuitry and any other possible circuitry or elements. The housing may include handles 322 or other features for aiding in plugging in and removing the adapter.

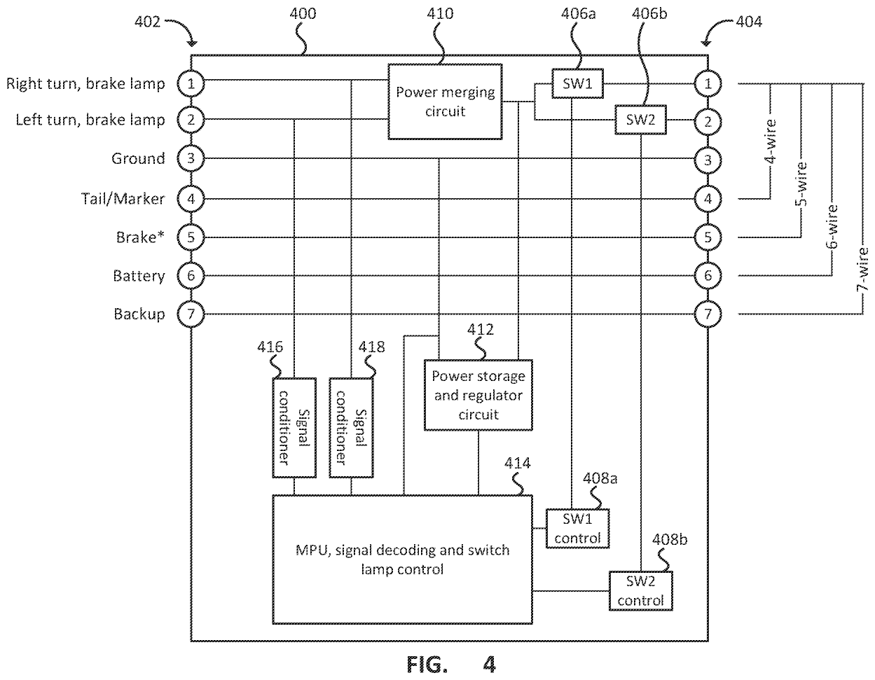

FIG. 4 depicts an illustrative schematic of light flashing circuitry. It will be appreciated that the same light flashing circuitry may be provided in various ways, although one particular implementation is depicted in FIG. 4. The adapter 400 is depicted as a 7-pin connector with 7 input pins 402 and 7 output pins 404. However, the adapter 400 may be a 4-pin, 5-pin, 6-pin or 7-pin adapter using substantially the same circuitry but with the appropriate number of input and output pins. As depicted, input and output pins #1 provide a right turn signal and a brake signal, input and output pins #5 provide an additional brake signal, input and output pins #6 provide a battery signal, and input and output pins #7 provide a backup signal. As depicted, the signals between the input and output pins #1 and #2 are broken within the adapter housing. The output pins #1 and #2 are driven by respective driving switches 406a, 406b which in turn may be controlled by respective control switches 408a, 408b. The input pins #1 and #2 are connected to power merging circuitry 410 that combines the signals from each of the #1 and #2 input pins and provides the combined signal to power storage and regulator circuit 412, which is also connected to the ground signal of input and output pins #3. The power from the power storage and regulator circuit 412 is provided to an MPU, signal decoding and switch lamp control circuit 414, along with the ground signal. The brake and turn signals received from input pins #1 and #2 are connected to respective signal conditioning circuitry 416, 418 which in turn provide the conditioned brake and turn signals to the MPU, signal decoding and switch lamp control circuit 414. The MPU, signal decoding and switch lamp control circuit 414 processes the input brake/turn signals and outputs control signals to respective switch controls 408a, 408b which in turn control the driving circuits 406a, 406b for outputting the appropriate brake and turn signals, which may be flashed, to the output pins #1, and #2.

Upon the application of power to either of the input lamp lines at input pins #1 and #2 the MPU circuitry 414 will power up, start analyzing the state of these signal lines as passed through the signal conditioners 416, 418 and pass the immediate high-low, or on/off, condition of the input lines to the output lamps connected to output pins #1 and #2 using either of SW1 or SW2 by controlling the control switches 408a, 408b. The input lines may be in various possible states, namely braking; turning right; turning left; hazards; braking and turning left; braking and turning right; or braking and hazards.

Upon determining a braking state the MPU will suspend the current output state, which was immediately applied, and inject or apply a new flashing state to the output pins.

The flash state provides 4 rapid flashes with equal on-off times to the brake lights and starts a pulse delay timer. The purpose of the pulse delay timer is to allow normal brake light conditions to occur within a reasonable time period. That is, if the brake lights are pulsed manually by the driver, the flashing circuitry does not flash the lights each time the brakes are applied. If the MPU detects another braking state before the pulse delay timer has expired, the regular brake lighting is applied and the pulse delay timer period may be extended. Once the pulse delay timer expires and another brake event occurs, the MPU may again enter a flash state to flash the brake lights when the brakes are applied.

As described above, a power storage component is attached to the MPU and provides a regulated power supply. The power storage components provide sufficient power storage to allow the MPU to continue to operate when the conditions of the input lines may not have power applied. The power storage supplies the necessary power to keep the MPU awake long enough to allow it to count down the pulse delay timer until it expires.

The power merging circuit isolates the input lines so the MPU can analyze the current state and also merges or combines the power from each line to one common connection. From this common connection the output power switches (SW1, SW2) are fed along with the power storage component. The signal conditioner components provide voltage level translation and noise reduction/immunity to the MPU so it can analyze the input signal states. The control switch circuits 408a, 408b provides voltage level translation from the MPU to the output driving switches SW1, SW2 406a, 406b.

It will be appreciated that although a specific implementation of the flashing circuitry is described above, there are a number of alternatives that may be implemented to provide the same light flashing functionality.

Although certain components have been described, it is contemplated that individually described components may be combined together into fewer components. Similarly, individual components may be provided by a plurality of components. One of ordinary skill in the art having regard to the current teachings will appreciate that the components described herein may be provided by various combinations of components, other than the specific implementations described herein as illustrative examples. Numerous additional variations on the apparatus of the various embodiments described above will be apparent to those skilled in the art in view of the above description. Such variations are to be considered within the teachings of the current description.

What is claimed is:

1. An adapter for a trailer's brake/signal lights comprising:
brake light flashing circuitry comprising a brake signal input and a brake signal output that is pulsed when a brake signal is applied at the brake signal input;
a first half of a vehicle-trailer connector comprising a plurality of physical electrical connections for removably connecting to a vehicle connection or a trailer connection, at least one of the electrical connections of the first half of the vehicle-trailer connector electrically connected to the brake signal input or the brake signal output of the brake light flashing circuitry; and
a body at least partially enclosing the brake light flashing circuitry and the first half of the vehicle-trailer connector.

2. The adapter of claim 1, wherein the first half of the vehicle-trailer connector comprises a vehicle side connector and is electrically connected to the brake signal output of the brake light flashing circuitry.

3. The adapter of claim 1, wherein the first half of the vehicle-trailer connector comprises a trailer side connector and is electrically connected to the brake signal input of the brake light flashing circuitry.

4. The adapter of any one of claims 1 to 3, wherein the first half of the vehicle-trailer connector comprises a first half of one of:
a 7-pin round connector;
a 7-pin flat connector;
a 6-pin round connector;
a 5-pin flat connector; and
a 4-pin flat connector.
